(19) United States
(12) Patent Application Publication
(10) Pub. No.: US 2010/0276233 A1
(43) Pub. Date: Nov. 4, 2010

(54) SYSTEM TO ELIMINATE ELECTRIC ACTUATOR CONTAMINATION

(75) Inventor: Eric D. Cahill, Troy, OH (US)

Correspondence Address: SNELL & WILMER L.L.P. (GOODRICH), ONE ARIZONA CENTER, 400 E. VAN BUREN STREET, PHOENIX, AZ, 85004-2202, US

(73) Assignee: GOODRICH CORPORATION, Charlotte, NC (US)

(21) Appl. No.: 12/433,075

(22) Filed: Apr. 30, 2009

(51) Int. Cl. F16D 55/00; F16D 55/22

(52) U.S. Cl. 188/73.47; 188/72.3

(57) ABSTRACT

A system to reduce or eliminate brake actuator contamination by providing a clean air source for the actuator such that a volume of a void in the actuator can vary without introducing moisture and/or contaminants into the actuator. A movable wall moves in response to changes in the volume of the void of the actuator to compensate for the changes without drawing moisture or contaminants into the actuator housing. By reducing or eliminating actuator contamination the service life of the actuator can be extended.

### FIELD OF THE INVENTION

The present invention relates generally to actuators and, more specifically, to actuators for brake systems.

### BACKGROUND OF THE INVENTION

Known in the prior art are aircraft wheel and brake assemblies including a non-rotatable wheel support, a wheel mounted to the wheel support for rotation, and a brake disk stack having front and rear axial ends and alternating rotor and stator disks mounted with respect to the wheel support and wheel for relative axial movement. Each rotor disk is coupled to the wheel for rotation therewith and each stator disk is coupled to the wheel support against rotation. A back plate is located at the rear end of the disk stack and a brake head is located at the front end. The brake head houses a plurality of actuator rams that extend to compress the brake disk stack against the back plate. Torque is taken out by the stator disks through a static torque tube or the like.

Electrically actuated aircraft brakes of various configurations are known, as exemplified by U.S. Pat. Nos. 4,381,049, 4,432,440, 4,542,809 and 4,567,967. The brake assemblies shown in these patents include electric motors which respond to an electrical control signal to effect rotation of a ring gear member which interacts through a plurality of balls to drive a linearly movable ram member into contacting engagement with a brake disk stack to effect compression thereof and braking of a wheel.

In U.S. Pat. No. 4,865,162, a further electrically actuated aircraft brake employs a roller screw drive mechanism driven by an electric torque motor through a gear drive associated with either the screw or the nut of the roller screw drive mechanism. Rotation of the gear drive by the torque motor moves the other one of the screw or nut into axial engagement with a brake disk stack to compress the stack for braking. A plurality of the roller screw drive mechanisms and respective gear drives and torque motors are mounted in a balanced arrangement about the axis of the wheel to apply and release a brake pressure force on the brake disk stack in response to an electrical control signal to the torque motors.

U.S. Pat. No. 6,095,293 discloses an electric brake and method characterized by the use of actuator modules each of which can be easily and quickly replaced as a unit. This enables quick and easy replacement of the actuator modules without requiring disassembly of the overall brake and wheel assembly. Also, it is conceivable that a malfunctioning actuator module could be replaced on an aircraft and tested with a minimum of equipment preferably quickly enough to allow the aircraft to remain in scheduled service and/or with a minimum of downtime. In addition, periodic maintenance of the brake can be done quicker and more efficiently by replacing the actuator modules with reconditioned and/or new actuator modules.

The electric brake described in U.S. Pat. No. 6,095,293 comprises a brake disk stack, a brake head, and at least one actuator module mounted to the brake head. The actuator module includes a module housing, a reciprocating ram and a motive device, i.e, an electric motor, operatively connected to the reciprocating ram for selectively moving the reciprocating ram into and out of forceful engagement with the brake disk stack for applying and releasing braking force. The actuator module is removable as a unit from one side of the brake head and most preferably from the side of the brake head opposite the brake disk stack. The ram includes a ram nut, and the electric motor is drivingly connected to a lead screw, e.g. a ball screw, in threaded engagement with the ram nut whereupon rotation of the lead screw effects linear movement of the nut toward and away from the brake disk stack. The module housing includes a guideway for guiding the ram nut, and the guideway and ram nut respectively have polygonal cross-sections defined by plural outer side surfaces which rotationally interfere with one another to restrain rotation of the ram nut relative to the housing.

International Publication No. WO 01/20188 also discloses another electro-mechanical actuator module including a housing, a linearly movable ram, a screw for linearly moving the ram, a nut mounted for rotation in the housing and operatively engaged with the screw such that rotation of the nut effects linear movement of the screw for urging the ram into forceful engagement with the brake disk stack, an electric motor for rotating the nut, and an anti-rotation device for preventing rotation of the screw relative to the housing when the nut is rotated to effect linear movement of the screw. This arrangement provides for greater stroke than prior art actuators without sacrificing durability and performance. To prevent foreign material from entering the housing at the screw, a bellows is used to provide a seal with respect to the housing and screw.

While such modular actuators represent an improvement insofar as ease of replacement, the actuators are still susceptible to contamination due to the infiltration of moisture and/or contaminants. For example, as an actuator ram moves during operation and/or over time from wear of the brake friction material, the actuator breathes as the void volume of the actuator changes. Breathing can introduce moisture and/or contaminants into the actuator that can lead to premature actuator wear and/or failure (e.g., seizure). Filters may provide a suitable solution in some instances, but generally are not effective at removing water vapor.

### SUMMARY OF THE INVENTION

The present invention provides a system to reduce or eliminate actuator contamination by providing a clean air source for the actuator. Thus, the void volume of the actuator can vary without introducing moisture and/or contaminants into the actuator thereby potentially extending the actuator service life and avoiding reliability issues that can result in aircraft downtime.

Accordingly, an actuator for a brake comprises a housing, a linearly movable member extending from the housing for compressively engaging a braking element to effect a braking action, and a movable wall that defines an enclosed chamber with the actuator housing. The enclosed chamber changes volume in response to movement of the linearly movable member and the wall moves to compensate for the changes in a volume of void of the actuator housing.

More particularly, the movable wall can be a diaphragm that forms a chamber together with the housing and linearly movable member. The actuator housing can generally be sealed except for an inlet for makeup flow from a makeup flow device that includes the movable wall. The makeup flow device can be a piston/cylinder arrangement having a first chamber connected to the actuator housing and a second chamber open to the atmosphere. The piston/cylinder arrangement can be mounted remotely from the actuator, and the first chamber can be connected to the actuator housing by a hose. The piston/cylinder arrangement can have a rod extending from the cylinder, with a degree of extension of the rod from the cylinder corresponding to a degree of brake wear. The actuator can be an electric actuator including an electric motor for driving the linearly movable member.

According to another aspect, a brake assembly comprises a brake disk stack and an actuator assembly for applying braking force to the brake disk stack, the actuator assembly including at least one actuator module having a housing and a linearly movable member extending from the housing for compressively engaging the brake disk stack. A movable wall defines an enclosed chamber with the actuator housing that changes volume in response to movement of the linearly movable member. The movable wall moves to compensate for changes in a volume of void of the actuator housing.

The actuator housing can be generally sealed except for an inlet for makeup flow from a makeup flow device that includes the movable wall. The makeup flow device can be a piston/cylinder arrangement having a first chamber connected to the actuator housing and a second chamber open to the atmosphere. The piston/cylinder arrangement can have a rod extending from the cylinder with a degree of extension of the rod from the cylinder corresponding to a degree of brake wear. The piston/cylinder arrangement can be mounted remotely from the actuator, and the first chamber can be connected to the actuator housing by a hose. The actuator can include a plurality of actuator modules and the makeup flow device can provide makeup flow to more than one actuator module. The at least one actuator can be an electric actuator including an electric motor for driving the ram.

Further features of the invention will become apparent from the following detailed description when considered in conjunction with the drawings.

### BRIEF DESCRIPTION OF THE DRAWINGS

FIG. 1 is a perspective view of a prior art electric brake.

FIG. 2 is a perspective view of an actuator module of the prior art brake of FIG. 1.

FIG. 3 is a cross-sectional view of the actuator module of FIG. 2 in a first position.

FIG. 4 is a cross-sectional view of the actuator module of FIG. 2 in a second position.

FIG. 5 is a schematic diagram of an exemplary actuator module in accordance with the invention in a first position.

FIG. 6 is a schematic diagram of the exemplary actuator module of FIG. 5 in a second position.

FIG. 7 is a schematic diagram of two exemplary actuator modules sharing a common piston/cylinder arrangement in accordance with the invention.

FIG. 8 is a schematic diagram of another exemplary actuator module in accordance with the invention.

### DETAILED DESCRIPTION

Because the invention was conceived and developed for use in an aircraft braking system, it will be herein described chiefly in this context. However, the principles of the invention in their broader aspects can be adapted to other types of braking systems, such as in train brake systems.

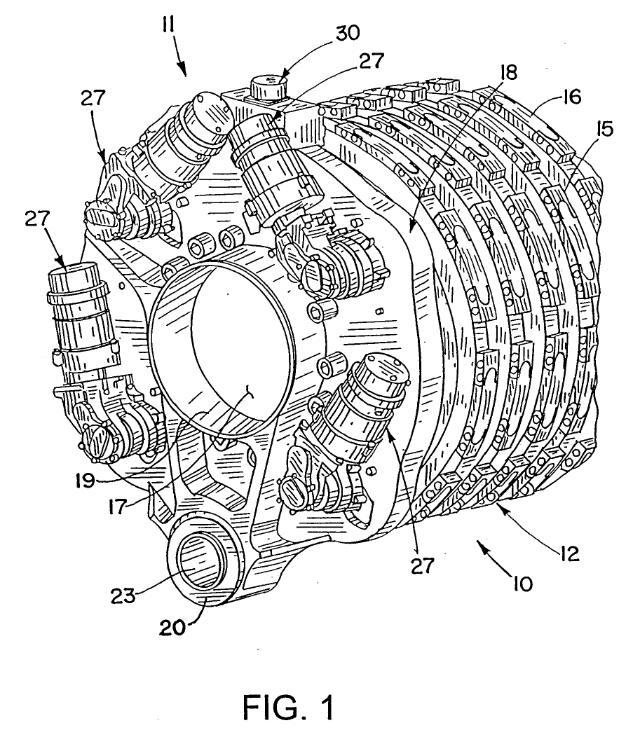

Referring now in detail to the drawings and initially to FIG. 1, an exemplary electric brake is generally indicated at 10. The brake 10 generally comprises a brake actuator assembly 11 and a heat sink in the form of a brake disk stack 12. The brake disk stack 12 can be of a conventional or other design including stationary brake elements and rotary brake elements that are interleaved and surround a torque tube or equivalent (not shown). The stationary and rotary brake elements usually are in the form of stator disks 15 and rotor disks 16. The stator disks 15 typically are splined to a torque tube 17 and the rotor disks 16 are splined to a wheel (not shown) interiorly of the wheel's rim. As is conventional, the splined connection may be effected by a plurality of spline or drive keys that are spaced around the circumference of the rim/torque tube to permit axial movement of the rotor/stator disks while being held to the wheel/torque tube against relative rotation.

The wheel (not shown) typically is supported for rotation on an axle (not shown) by axially spaced apart bearings (not shown). The axle thus forms a wheel mount and typically is attached to an aircraft landing gear strut or truck (not shown). For further details, reference may be had to U.S. Pat. No. 6,662,907, which is hereby incorporated herein by reference in its entirety.

The brake actuator assembly 11 includes a brake head 18 that can also be referred to as a brake housing or, in the present case, more particularly as a brake mounting plate. The brake mounting plate has a central opening 19 for mounting of the brake mounting plate on the landing gear axle or other wheel support. For some applications the brake mounting plate can be formed integrally with or fixedly secured (as by splines, bolts, etc.) to the axle or other wheel support for direct transfer of braking torque to the axle or other wheel support. In the illustrated embodiment, the brake mounting plate is supported on the axle for limited rotational movement, and the brake mounting plate is provided with an torque take-out arm 20. The torque take-out arm 20 extends radially and functions as a torque transfer interface between the brake actuator assembly and the landing gear axle/strut/truck structure. More particularly, the torque take-out arm 20 has an eye 23 that provides for connection to a brake rod that in turn is connected to the landing gear axle/strut/truck structure, as in a conventional manner, to provide for transfer of torque from the torque take-out arm to the landing gear axle/strut/truck structure when braking force is being applied to the disk brake stack 12 by the brake actuator assembly 11.

The disk stack 12 typically is located between a back pressure member (not shown) and the brake mounting plate 18. The back pressure member can be formed by a radial flange at the end of the torque tube opposite the brake mounting plate, which radial flange engages the last brake disk at the outboard end of the disk stack typically through the use of a plurality of circumferentially spaced apart pucks. For further details, reference may be had to U.S. Pat. No. 6,662,907.

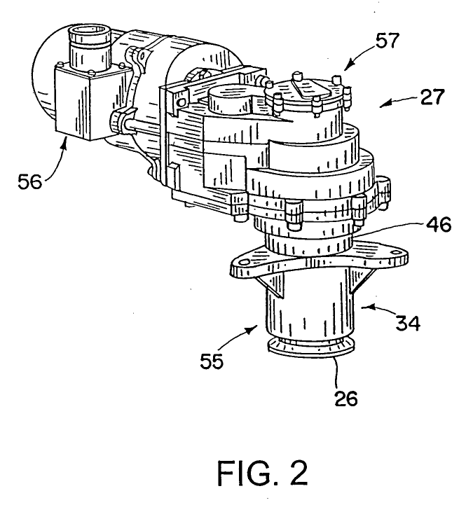

Pressure is applied to the other or inboard end of the disk stack 12 by the ram 26 (FIG. 2) of one or more actuator modules 27 that are mounted to the brake mounting plate 18. The actuator modules 27 preferably are mounted in a circular arrangement around the center axis of the brake mounting plate 18, preferably with the actuator rams 26 generally circumferentially equally spaced apart and/or with the rams arranged in diametrically opposed pairs. The actuator modules 27 can be connected by any suitable means such as cables to a single interface connector 30 to which a mating connector of a control cable (not shown) can be detachably connected for connecting the brake 10 to a brake controller (not shown) located elsewhere. The brake mounting plate serves as the platform for mounting the actuator modules and for reacting actuation and torque loads from the brake to an aircraft brake rod or other landing gear structure.

As shown in FIG. 2, the housing 34 of each actuator module 27 can be formed from several parts, and these parts can be associated with respective parts or sections of the actuator module. Generally, the actuator module has a ram drive section 55, a motor section 56 and a transmission section 57 connecting the ram drive section to the motor section. These sections can be removable with respect to one another, as might be desired to facilitate assembly and/or refurbishing the actuator module.

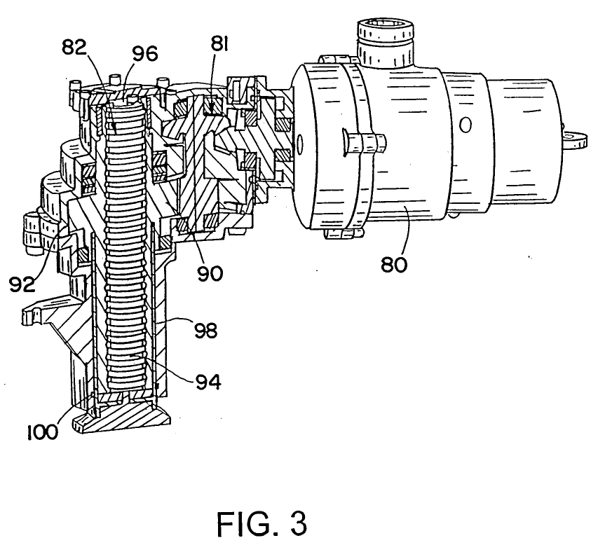

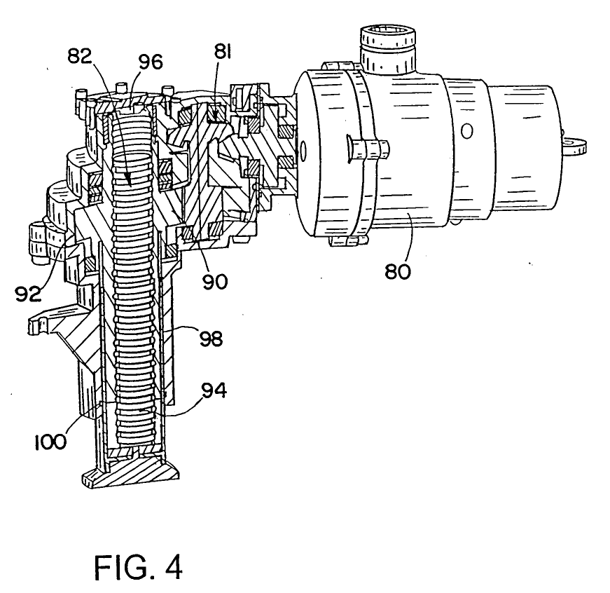

Referring now to FIGS. 3 and 4, the illustrated representative actuator module 27 includes an electric motor 80, a multi-stage reduction gear train 81, and a ball screw assembly 82. The motor 80, gearing 81 and ball screw assembly 82 are all carried in the module housing 34. Suitable bearings are provided for the various rotating components. An electrical connector can be provided on the housing for interfacing the motor with control circuitry.

The ball screw assembly 82 includes a ball nut 90 having a gear 92 in mesh with the output end of gearing 81. The ball screw assembly further includes a ball screw 94 that moves linearly upon rotation of the ball nut, an anti-rotation guide member 96 extending into the hollow interior of the ball screw, and a ram sleeve 98 that is telescoped over an axially outer portion of the ball nut. The ball screw and ball nut have respective spiral grooves/threads and associated balls for converting rotary motion to linear motion. Also, other rotary to linear motion conversion devices may by employed, if desired, with the linear moving member coinciding with the ball screw and functioning at its outboard end as the actuator ram. In the illustrated ball screw assembly, the interior bore of the screw and the anti-rotation guide have corresponding non-circular, e.g. polygonal, cross-sections which rotationally interfere with one another to restrain rotation of the screw relative to the housing.

The ball screw assembly translates the rotary motion from the gear train to the linear motion at the actuator output. Mechanical stops can be provided to limit the stroke of the translating screw, and a stop can be used as an absolute position indicator for calibrating the actuator stroke position.

The translating ball screw functions as the actuator ram and contacts the carbon brake disc stack through an insulator. For example, the ball screw assembly 82 is shown in an extended position in FIG. 4 with the ball screw 94 shifted axially from its position shown in FIG. 3. The screw can be made of Inconel for thermal considerations. By simply changing the ball screw assembly the stroke length can easily be modified to allow the actuator to operate on many different aircraft brake assemblies with different stroke lengths.

The ram sleeve 98, which can be attached to the end of the ball screw, provides a sealing enclosure and can also function as an insulating interface with the brake disk stack. A dynamic seal/scraper 100 is used to seal the ram sleeve to the housing to prevent fluid from entering the actuator. The sleeve telescopically slides on a cylindrical end portion of the ram nut with a sliding fit in the housing. The sleeve has a length sufficient to cover the length of the screw that will project from the housing at full extension, while still remaining coextensive with the ram nut.

As will be appreciated, rotation of the motor 80 in one direction will effect extension of the screw/ram for engaging and squeezing the brake disk stack, whereas rotation in the opposite direction will effect retraction of the ram, as for releasing braking force. In any given position of the ram, the gear train can be locked by the bi-stable holding brake if the gearing or motor is so-equipped. This is desirable, for example, to retain the ram in an extended position applying braking force to the brake disk stack when the plane is parked, thereby to keep the brake engaged to prevent movement of the aircraft.

Even though the actuator module 27 may be generally sealed, extension of the screw/ram from the actuator housing during braking activities leaves a void within the housing 34 that results in air being drawn into the actuator module 27. Such air may contain water vapor and/or contaminants that can lead to premature wear and/or require more frequent replacement/repair of the actuator module 27.

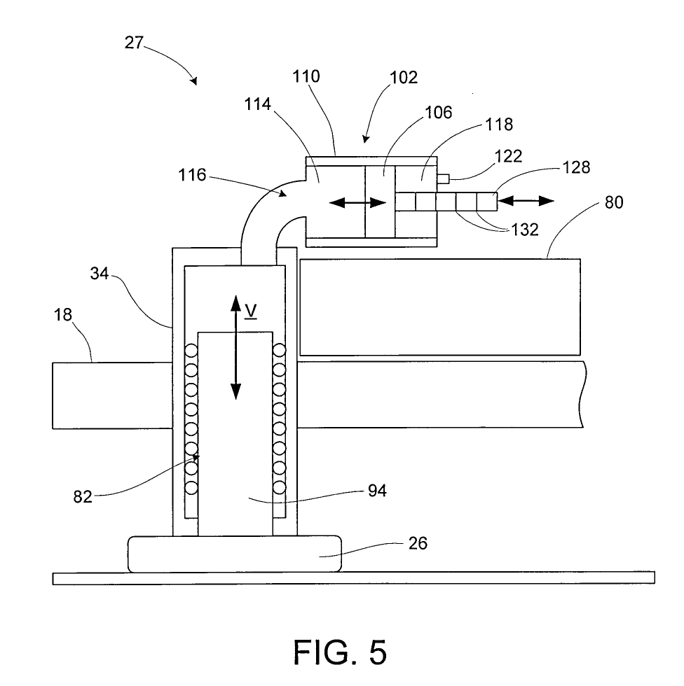

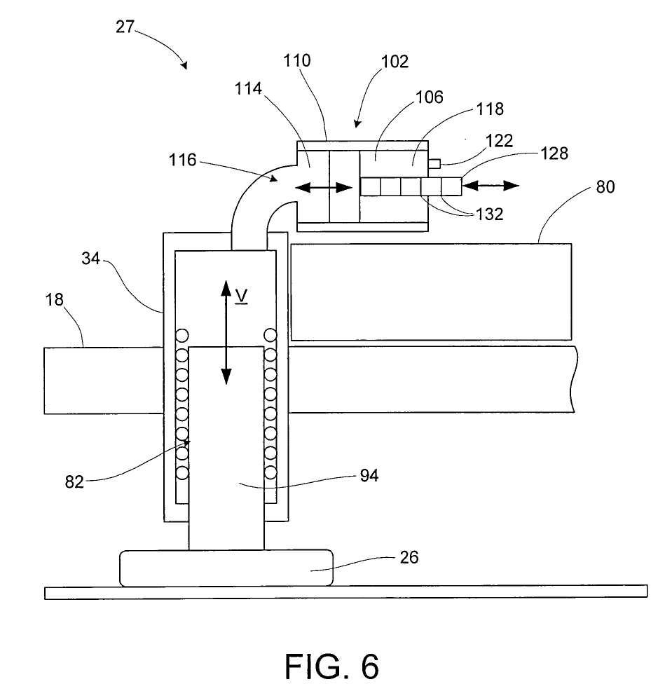

Turning to FIGS. 5 and 6, and in accordance with the invention, an actuator module 27, such as described above, is schematically illustrated with a movable wall that compensated for changes in a volume of void V of the actuator housing 34 so as to reduce or eliminate contamination of the actuator housing with dirt, moisture, etc.

In the illustrated embodiment, a piston and cylinder arrangement 102 provides a source of clean make-up fluid, which may be a liquid or a gas, to the actuator module 27. The piston and cylinder arrangement includes a piston 106 (e.g., movable wall) supported within a cylinder 110 for sliding axial movement. The piston 106 divides the cylinder 110 into first and second chambers 114 and 118 that are generally sealed from each other. In this regard, a seal (not shown), may typically be provided for sealing the piston 106 to the inside diameter of the cylinder 110.

The first chamber 114 of the piston/cylinder arrangement 102 is fluidly connected to the interior of the housing 34 of the actuator module 27 by a tube 116 or other suitable conduit. The second chamber 118 is open to the atmosphere, for example, via port 122. Thus, air is free to move into and out of the second chamber 118 in response to movement of the piston 106 within the cylinder 110. Although the second chamber 118 is illustrated as open to atmosphere, it could alternatively be connected to a fluid reservoir or other source of fluid, for example. If open to the atmosphere, one or more drain holes could be provided for draining accumulated liquid from the second chamber 118.

With reference to FIG. 6, during operation of the actuator module 27 the ball screw 94 shifts axially within the housing 34. This axial shifting results in a change in the void volume V of the interior of the housing 34 causing respective negative and positive pressures within the housing 34. In the past, such pressure differentials were typically equalized by the influx or outflow of ambient air, moisture, contaminants, etc. into the actuator housing 34.

In accordance with the invention, the piston/cylinder arrangement 104 provides closed system makeup flow to the actuator module 27 thereby allowing the actuator module 27 to breathe without inducing moisture and/or contaminants to the interior of the housing 34. Thus, for example, as the void volume V of the actuator module 27 increases resulting in a negative pressure, fluid is drawn into the actuator housing 34 from chamber 114 of the piston/cylinder arrangement 104. If the void volume of the actuator module 27 decreases, the resulting positive pressure results in fluid being expelled from the housing 34 to chamber 114. As will be appreciated, the fluid (e.g., air) in the first chamber 114 is generally isolated from environmental contaminants such as moisture and particulates thus providing a source of clean makeup flow to the actuator module 27.

Over time, the friction material of the brake will typically wear down resulting in an overall increase in the void volume V of the actuator housing 34 as the screw 94 extends further and further out of the housing 34. Accordingly, the volume of chamber 114 will tend to decrease to compensate for the increase in volume of the void V. A piston rod 128 extending from the cylinder 108 can be provided as illustrated to give a visual indication of the state of brake wear based on the length of the piston rod 128 extending from the cylinder 110, wherein a degree of extension of the rod from the cylinder corresponds to a degree of brake wear.

For example, the piston rod 128 can include graduations 132 as shown corresponding to varying levels of wear. The illustrated piston rod 128 of FIG. 5 may be considered to indicate a slight amount of wear. As wear increases and the piston rod 128 shifts leftward such as shown in FIG. 6 (i.e., into the cylinder 110), less of the piston rod 128 will extend from the housing thereby indicating more wear. A sensor (not shown) may be provided for sensing the position of the piston rod 128 in order to sense brake wear. Such a brake wear indicator would typically be provided in addition to standard brake wear indicators and/or sensors, or to provide a simple visual indicator of break wear useful during brake inspection. Such indicators could be placed in a location on an aircraft that is easily viewed by maintenance personnel, for example.

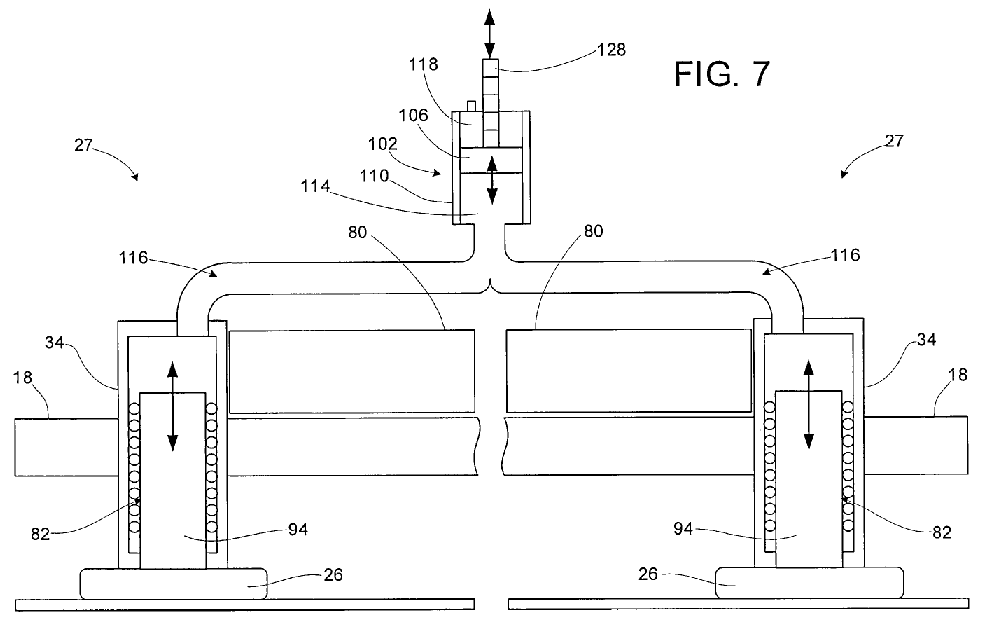

Turning now to FIG. 7, another exemplary embodiment in accordance with the present invention in illustrated. In this embodiment, two actuator modules 27 share a common piston/cylinder arrangement 102. As will be appreciated, virtually any number of actuator modules 27 could share a common piston/cylinder arrangement 102 provided that the piston/cylinder arrangement is appropriately sized.

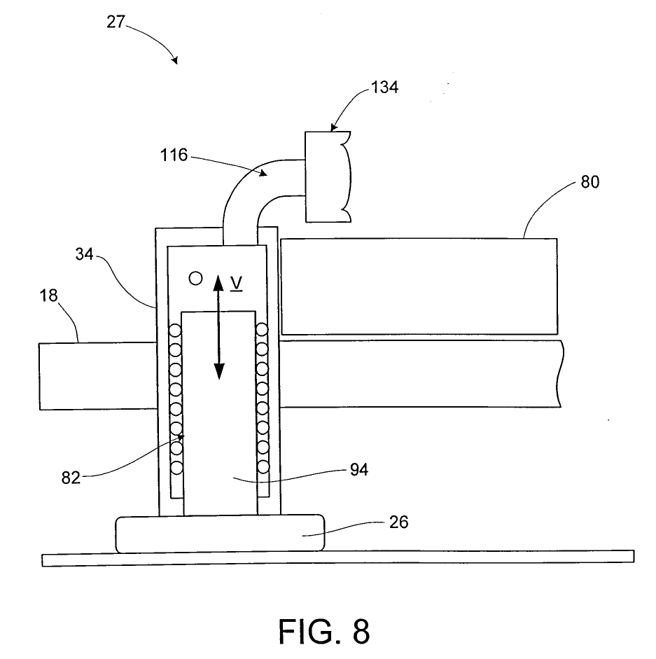

In FIG. 8 another exemplary actuator module 27 is illustrated. The actuator module 27 is identical to the actuator modules of FIGS. 5 and 6 with the exception of the closed loop makeup flow device. In FIG. 8, a diaphragm 134 is provided instead of the piston/cylinder arrangement.

The diaphragm 134, as will be appreciated, is configured to flex in response to changes in pressure within the actuator housing 34 due to a change in void volume V therein to supply makeup flow to the actuator housing 34. Accordingly, the diaphragm 134 works in much the same way as the piston/cylinder arrangement 102 in FIGS. 5 and 6 by providing a source of clean makeup flow to the actuator to prevent contamination thereof. As will be appreciated, the diaphragm 134 could be integral with the actuator housing 34 forming a portion thereof, for example, and a brake wear indicator could be provided wherein a degree of flex of the diaphragm corresponds to a degree of brake wear.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An actuator for a brake comprising a housing, a linearly movable member extending from the housing for compressively engaging a braking element to effect a braking action, and a movable wall that defines an enclosed chamber with the actuator housing, the enclosed chamber changing volume in response to movement of the linearly movable member, whereby the wall moves to compensate for changes in a volume of void of the actuator housing.

2. An actuator as set forth in claim 1, wherein the actuator housing is generally sealed except for an inlet for makeup flow from a makeup flow device that includes the movable wall.

3. An actuator as set forth in claim 2, wherein the makeup flow device is a piston/cylinder arrangement having a first chamber connected to the actuator housing and a second chamber open to the atmosphere.

4. An actuator as set forth in claim 3, wherein the piston/cylinder arrangement is mounted remotely from the actuator, and the first chamber is connected to the actuator housing by a hose.

5. An actuator as set forth in claim 3, wherein the piston/cylinder arrangement has a rod extending from the cylinder, and wherein a degree of extension of the rod from the cylinder corresponds to a degree of brake wear.

6. An actuator as set forth in claim 1, wherein the actuator is an electric actuator including an electric motor for driving the linearly movable member.

7. An actuator as set forth in claim 1, wherein the movable wall is a diaphragm that forms a chamber together with the housing and linearly movable member.

8. A brake assembly comprising a brake disk stack having a center axis, and at least one actuator according to claim 1 for applying braking pressure to the brake disk stack.

9. A brake assembly comprising a brake disk stack and an actuator assembly for applying braking force to the brake disk stack, the actuator assembly including at least one actuator module having a housing and a linearly movable member extending from the housing for compressively engaging the brake disk stack, and a movable wall that defines an enclosed chamber with the actuator housing, the enclosed chamber changing volume in response to movement of the linearly movable member, whereby the movable wall moves to compensate for changes in a volume of void of the actuator housing.

10. A brake assembly as set forth in claim 9, wherein the actuator housing is generally sealed except for an inlet for makeup flow from a makeup flow device that includes the movable wall.

11. An actuator as set forth in claim 10, wherein the makeup flow device is a piston/cylinder arrangement having a first chamber connected to the actuator housing and a second chamber open to the atmosphere.

12. An actuator as set forth in claim 11, wherein the piston/cylinder arrangement has a rod extending from the cylinder, and wherein a degree of extension of the rod from the cylinder corresponds to a degree of brake wear.

13. A brake assembly as set forth in claim 11, wherein the piston/cylinder arrangement is mounted remotely from the actuator, and the first chamber is connected to the actuator housing by a hose.

14. A brake assembly as set forth in claim 9, wherein the actuator includes a plurality of actuator modules, and wherein the makeup flow device provides makeup flow to more than one actuator module.

15. A brake assembly as set forth in claim 9, wherein the at least one actuator is an electric actuator including an electric motor for driving the ram.

16. A brake assembly as set forth in claim 9, wherein the movable wall is a diaphragm that forms a chamber together with the housing and linearly movable member.
